(19) United States
(12) Patent Application Publication
(10) Pub. No.: US 2005/0064116 A1
(43) Pub. Date: Mar. 24, 2005

(54) Polymer gel display, fabrication method and operating structure thereof

(76) Inventors: Yi-An Sha, Taipei (TW); Ing Jer Lin, Hsinchu (TW); Yi-Chun Wong, Tainan (TW); Lung-Pin Hsin, Taichung (TW); Chi-Chang Liao, Tainan (TW); Hsin-Chun Chiang, Hsinchu (TW); Yang-Yi Fan, Taichung (TW); Chung-Wen Wu, Taipei (TW)

Correspondence Address: BIRCH STEWART KOLASCH & BIRCH, PO BOX 747, FALLS CHURCH, VA, 22040-0747, US

(21) Appl. No.: 10/780,711

(22) Filed: Feb. 19, 2004

(30) Foreign Application Priority Data
Sep. 23, 2003 (TW) 92126162

(51) Int. Cl. E06B 3/24

(52) U.S. Cl. 428/34

(57) ABSTRACT

A polymer gel display, fabrication method and operating structure thereof. Display is enabled by utilizing the flexing characteristic of a polymer-gel sheet. A pair of substrates is separated by a predetermined gap, and a polymer-gel sheet of a first color disposed therebetween, having two ends fixed, a center area flexible and contacting no more than one of the substrates. A fluid layer of a second color is disposed between the substrates, displaying its color via the substrate not contacting the polymer-gel sheet. An external electric field is applied to the polymer-gel sheet, flexing the polymer-gel sheet toward the substrate until making contact and the first color of the polymer-gel sheet is displayed via the substrate.

### BACKGROUND OF THE INVENTION

1. Field of the Invention

The present invention relates to a display, and more particularly to a polymer gel display, and the fabrication method and operating structure thereof.

2. Description of the Related Art

Liquid crystal displays (LCD) are commonly used for flat panel display. Owing to dielectric anisotropy and conductive anisotropy of liquid crystal molecules, molecular orientation of liquid crystals can be shifted under an external electronic field, such that various optical effects are produced.

With the progress in development of flexible displays, electronic paper and electronic books, a lack of flexibility, combined with complex low-temperature manufacture limits the use of LCDs. A new display employing non-liquid crystals is therefore needed. For example, the motion of a charged particle in an electric field has been employed as an operating structure by E-Ink, Si-Pix and Bridgestone companies. The dissociation and precipitate of silver has also been employed as an operating structure by Sony. In addition, operating structures involving electrochromism have been presented.

Furthermore, Xerox provides a series of display technologies utilizing polymer gel as a display element. For example, black particles of polymer gel and an electrolyte are disposed between two electrodes, and display is then enabled by the volume change (either increasing or decreasing) of the particles, providing a dark state when the volume increases, and a light state when the volume decreases. However, particles of polymer gel aggregate easily, creating problems in dispersion.

### SUMMARY OF THE INVENTION

Accordingly, an object of the present invention is to provide a polymer gel display, the fabrication method and operating structure thereof.

Therefore, the invention utilizes a polymer-gel sheet as a display medium. Without the disadvantages of polymer-gel particles such as frequent aggregation and complex manufacture, the polymer-gel sheet, disposed between two electrodes, results in a dark/light contrast by its flexing characteristics, owing to the mobility of ions in an electrolyte and/or polymer-gel sheet, in company with a colored electrolyte or optical reflective layer.

According to the invention, the polymer gel display comprises a first substrate, with a polymer-gel sheet disposed thereon, and two ends fixed thereon and a flexible center area, a pair of second spacers disposed on the two ends of the polymer-gel sheet to fix the two ends to the first substrate, a second substrate disposed on the first substrate with a certain gap therebetween, such that the polymer-gel sheet contacts the second substrate when the center area is flexed and displays via the second substrate, and a fluid layer between the first and second substrates.

According to the invention, a fabrication method of the polymer-gel display comprises the steps of providing a first substrate, disposing a polymer-gel sheet thereon, with two ends fixed thereon and a flexible center area, disposing a pair of second spacers on the two ends of the polymer-gel sheet to fix the two ends to the first substrate, disposing a second substrate on the first substrate with a certain gap therebetween, such that the polymer-gel sheet contacts the second substrate when the center area is flexed and displays via the second substrate, and disposing a fluid layer between the first and second substrates.

According to the invention, the operating structure of the polymer-gel display, utilizing the flexing of the polymer-gel sheet to enable the display, comprises a pair of substrates with a certain gap therebetween, a polymer-gel sheet of a first color disposed between the substrates, without contact with at least one of the substrates, having two fixed ends and a flexible center area, and a fluid layer of a second color between the substrates, displaying the second color via the substrate not contacting the polymer-gel sheet, wherein the center area of the polymer-gel sheet flexes toward the substrate originally not contacting thereto when an external electric field is applied, such that the first color of the polymer-gel sheet is displayed via the substrate after the polymer-gel sheet and the substrate make contact.

### DESCRIPTION OF THE DRAWINGS

The present invention can be more fully understood by reading the subsequent detailed description and examples with references made to the accompanying drawings, wherein:

FIG. 1 shows the inventive polymer gel display;

FIG. 2 illustrates the operating structure of the polymer gel display of FIG. 1;

FIG. 3 shows another example of the inventive polymer gel display;

FIG. 4 illustrates the operating structure of the polymer gel display of FIG. 3;

FIG. 5 shows yet another example of the inventive polymer gel display;

FIG. 6 illustrates the operating structure of the polymer gel display of FIG. 5; and

FIG. 7 shows still another example of the inventive polymer gel display; and

FIG. 8 illustrates the operating structure of the polymer gel display of FIG. 7.

### DETAILED DESCRIPTION OF THE INVENTION

Regarding the above-mentioned flexing characteristic of a polymer-gel sheet in an electric field, much research has been conducted, such as in “Deformation behaviors of polymer gels” (Polymer Gels, D. DeRossi et al. (editor), Plenum Press, New York, p.p. 237-246, 1991).

The invention, focusing on the flexing characteristic of polymer gels, therefore provides a polymer gel display with polymer-gel sheet as a display medium.

According to the invention, the polymer gel display may further comprise a pair of first spacers between the polymer-gel sheet and the first substrate, wherein the first spacers are disposed corresponding to the second spacers such that the center area of the polymer-gel sheet is suspended over the first substrate.

According to the invention, the polymer gel display may further comprise a first conducting layer between the first substrate and the polymer-gel sheet, and a second conducting layer between the second substrate and the polymer-gel sheet. The second conducting layer may be disposed between the second substrate and the second spacers or between the polymer-gel sheet and the second spacers, while the first conducting layer may be disposed between the first substrate and the first spacers or between the polymer-gel sheet and the first spacers.

The first and second spacers may be conducting spacers, and the first and second substrates may be transparent glass substrates. The polymer-gel sheet may be a PMMA (polymethyl methacrylate)-gel, polyamide-gel, or polyvinyl fluoride-gel sheet. The polymer-gel sheet is preferably colored, for example black or white, by adding black or white pigments thereto.

The fluid layer may further comprise an electrolyte and a pigment with color different from that of the polymer-gel sheet. For example, white pigment may be added to the fluid layer when the polymer-gel sheet is black, and black pigment may be added to the fluid layer when the polymer-gel sheet is white. In addition, the fluid layer may further comprise gas as a carrier of the pigment to reduce the weight of the display.

Several inventive polymer gel displays are given as examples in the following to explain their operating structures.

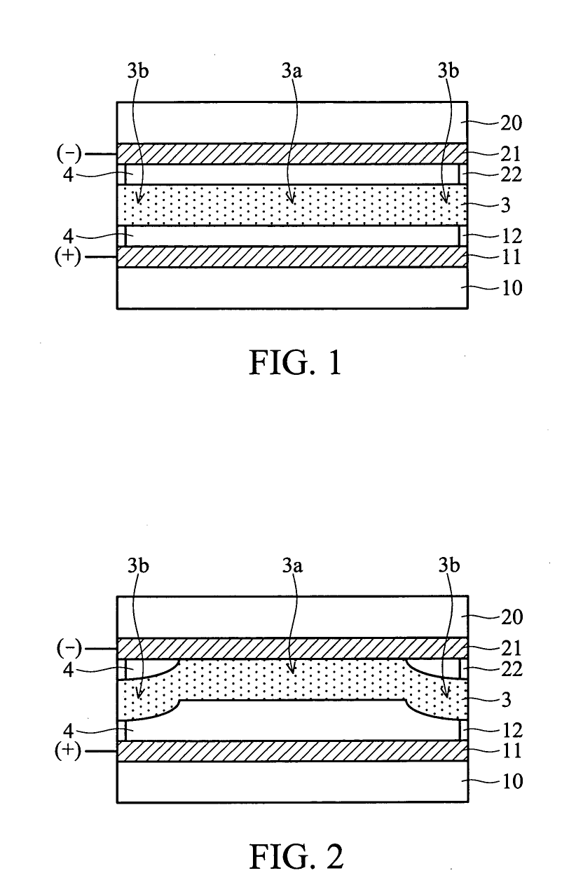

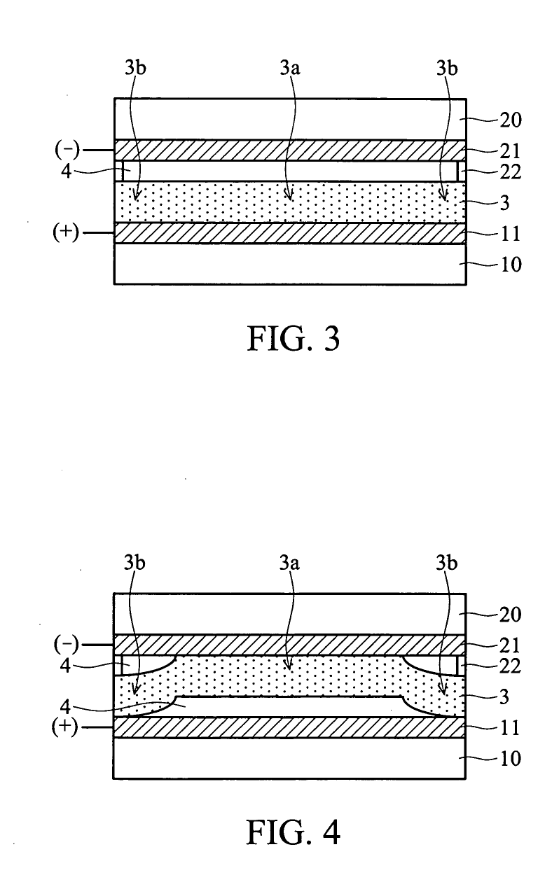

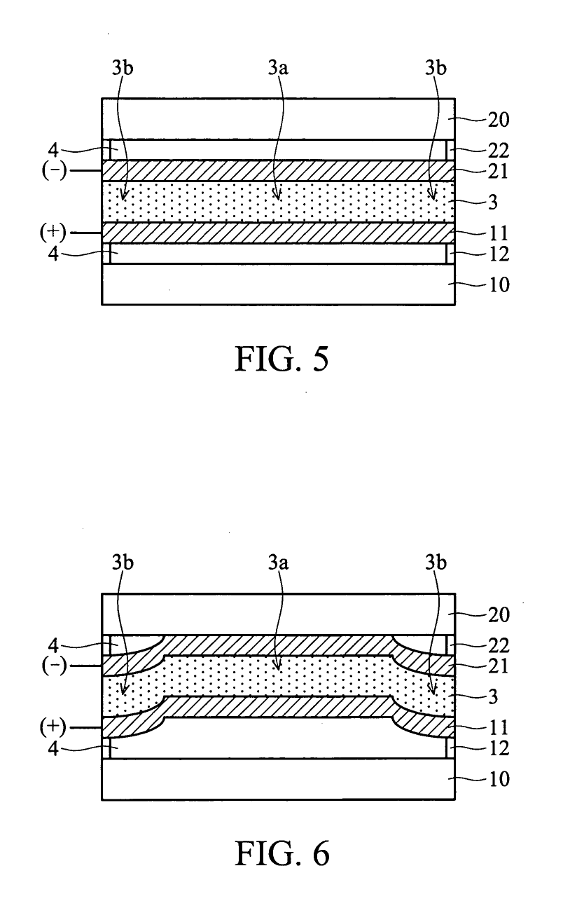

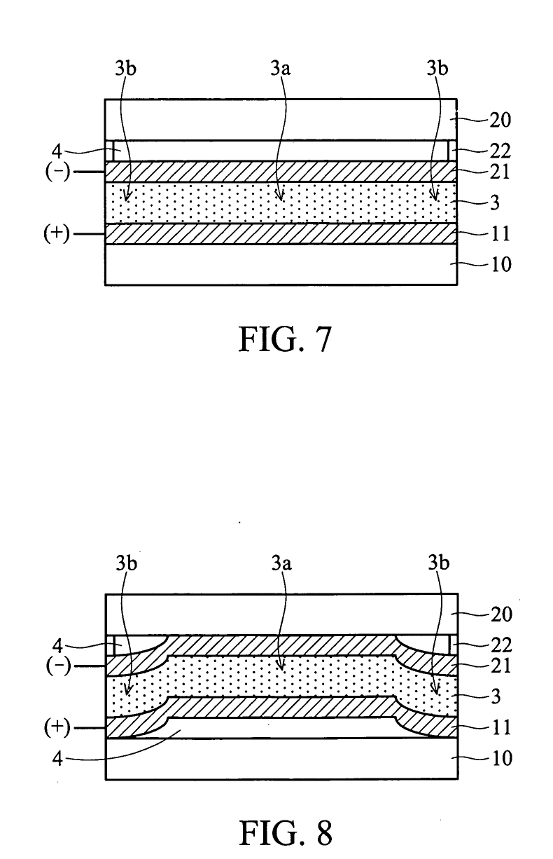

FIG. 1, FIG. 3, FIG. 5 and FIG. 7 show four kinds of inventive polymer gel displays, and their operating structures are illustrated in FIG. 2, FIG. 4, FIG. 6 and FIG. 8.

In FIG. 1, a pair of substrates 10, 20 is respectively provided with transparent conducting layers 11, 21. The substrates 10, 20 are transparent substrates made of, for example, glass or polymeric materials. The transparent conducting layers 11, 21 are made of transparent conducting materials such as indium tin oxide or conducting polymers. Spacers 12, 22 are applied to support a polymer-gel sheet 3 and fix the two ends 3b of the polymer-gel sheet 3 such that the center area 3a of the polymer-gel sheet 3 is suspended between the substrates 10, 20. The polymer-gel sheet is of, for example, polymethyl methacrylate, polyamide, or polyvinyl fluoride. A pigment or colored particles such as carbon black may be added to the polymer-gel sheet 3. A fluid layer 4 of, for example, an electrolyte is injected between the substrates 10, 20, and a pigment may be added thereto.

FIG. 2 illustrates the flexing of the polymer-gel sheet 3 in an electric field. Owing to the electric field, the side of the center area 3a facing the positively-charged transparent conducting layer 11 is electrically induced to be negatively charged, such that a local solvent-discharge effect results, and the volume of the negatively-charged side of the polymer-gel sheet 3 decreases. In the contrary, the side of the center area 3a facing the negatively-charged transparent conducting layer 21 is electrically induced to be positively charged, such that a local solvent-absorption effect results, and the volume of the positively-charged side of the polymer-gel sheet 3 increases. The above solvent discharge and absorption effects flex the center area of the polymer-gel sheet 3a toward the substrate 20 until contact is achieved, and the display color of the area of the substrate 20 contacting the polymer-gel sheet 3 thereby changes to that of the polymer-gel sheet 3.

FIG. 3 shows another example of the polymer gel display, and FIG. 4 illustrates the operating structure thereof. The operating structure is similar to that of FIG. 2, except that the polymer-gel sheet 3 originally contacts the lower substrate 10 before an electric field is applied. The flexing characteristic of the polymer-gel sheet 3 is also utilized to achieve display.

FIG. 5 shows still another example of the polymer gel display, and FIG. 6 illustrates the operating structure thereof. The operating structure is similar to that of FIG. 2, except that the spacers 12, 22 act as electrodes in addition to providing support, and transparent conducting layers (and/or ion exchange films) 11, 21 are coated on the polymer-gel sheet 3.

FIG. 7 shows still another example of the polymer gel display, and FIG. 8 illustrates the operating structure thereof, a combination of those shown in FIG. 4 and FIG. 6.

First Embodiment

Preparation of Polymer-Gel Sheet

A reaction flask was charged with deionized water (400 ml), acrylic acid (300 g), acrylic amide (300 g), methylene bisacrylamide (3 g), sodium hydroxide (5 g), and titanium oxide powder (8 g). Nitrogen was introduced into the flask, and the mixture was stirred at room temperature for 2 hours to remove oxygen from the solution. 4 g of accelerator (tetramethylethylenediamine, TEMED) and 0.8 g of initiator (potassium persulfate) were added to the mixture, which was then cast on a sheet module to a thickness of 200 μm. The module was then heated to 50° C. for polymerization, and a white polymer-gel sheet 3 was obtained.

Preparation of Polymer Gel Display

The polymer-gel sheet 3 was then applied in fabrication of a polymer gel display as shown in FIG. 1. The polymer gel display included a stacked structure comprising the white polymer-gel sheet 3, two electrodes of indium tin oxide (ITO) 11, 21, and spacers 12, 22. A fluid layer 4 within the display was filled with sodium carbonate of 0.01M and black pigment S-428 (Trade name, Mitsui Chemical co.) of 0.001 g/ml. The polymer-gel sheet 3 and the ITO electrodes 11, 21 were spaced at 20 μm.

Operating Structure

By applying a positive voltage to the transparent conducting layer 11 and a negative voltage to the transparent conducting layer 21, the polymer-gel sheet 3 was subjected to an electric field. Owing thereto, the side of the center area 3a facing the positively-charged transparent conducting layer 11 was electrically induced to be negatively charged, such that a local solvent-discharge effect resulted, and the volume of the negatively-charged side of the polymer-gel sheet 3 reduced. Additionally, the side of the center area 3a facing the negatively-charged transparent conducting layer 21 was electrically induced to be positively charged, such that a local solvent-absorption effect resulted, and the volume of the positively-charged side of the polymer-gel sheet 3 increased. The above solvent discharge and absorption effects flexed the center area of the polymer-gel sheet 3a toward the substrate 20 until contact is achieved, and the display color of the area of the substrate 20 contacting the polymer-gel sheet 3 thereby changed to that of the polymer-gel sheet 3 (white).

Second Embodiment

Preparation of Polymer-Gel Sheet

A reaction flask was charged with deionized water (400 ml), acrylic acid (300 g), acrylic amide (300 g), methylene bisacrylamide (3 g), sodium hydroxide (5 g), and carbon black powder (6 g). Nitrogen was introduced into the flask, and the mixture was stirred at room temperature for 2 hours to remove oxygen from the solution. 4 g of accelerator (tetramethylethylenediamine, TEMED) and 0.8 g of initiator (potassium persulfate) were added to the mixture, which was then cast on a sheet module to a thickness of 200 μm. The module was then heated to 50° C. for polymerization, and a black polymer-gel sheet 3 was obtained.

Preparation of Polymer Gel Display

The polymer-gel sheet 3 was then applied in fabrication of a polymer gel display as shown in FIG. 1. The polymer gel display included a stacked structure comprising the black polymer-gel sheet 3, two electrodes of indium tin oxide (ITO) 11, 21, and spacers 12, 22. A fluid layer 4 within the display was filled with sodium carbonate of 0.01M and white pigment (titanium oxide) of 0.05 g/ml. The polymer-gel sheet 3 and the ITO electrodes 11, 21 were spaced at 20 μm.

Operating Structure

By applying a positive voltage to the transparent conducting layer 11 and a negative voltage to the transparent conducting layer 21, the polymer-gel sheet 3 was subjected to an electric field. Owing thereto, the side of the center area 3a facing the positively-charged transparent conducting layer 11 was electrically induced to be negatively charged, such that a local solvent-discharge effect resulted, and the volume of the negatively-charged side of the polymer-gel sheet 3 reduced. Additionally, the side of the center area 3a facing the negatively-charged transparent conducting layer 21 was electrically induced to be positively charged, such that a local solvent-absorption effect resulted, and the volume of the positively-charged side of the polymer-gel sheet 3 increased. The above solvent discharge and absorption effects flexed the center area of the polymer-gel sheet 3a toward the substrate 20 until contact is achieved, and the display color of the area of the substrate 20 contacting the polymer-gel sheet 3 thereby changed to that of the polymer-gel sheet 3 (black).

Third Embodiment

Preparation of Polymer-Gel Sheet

A reaction flask was charged with deionized water (400 ml), acrylic acid (300 g), acrylic amide (300 g), methylene bisacrylamide (3 g), and sodium hydroxide (5 g). Nitrogen was introduced into the flask, and the mixture stirred at room temperature for 2 hours to remove oxygen from the solution. 4 g of accelerator (tetramethylethylenediamine, TEMED) and 0.8 g of initiator (potassium persulfate) were added to the mixture, and the mixture was then cast between two platinum film electrodes to form a sandwich-like structure. The thickness of the mixture was 200 μm, and the sandwich-like structure was then heated to 50° C. for polymerization, and a polymer-gel sheet 3 was obtained.

Preparation of Polymer Gel Display

The polymer-gel sheet 3 was then applied in fabrication of a polymer gel display as shown in FIG. 5. The polymer gel display included a stacked structure comprising the polymer-gel sheet 3, two platinum electrodes 11, 21, two glass substrates 10, 20, and conducting spacers 12, 22. A fluid layer 4 within the display was filled with sodium carbonate of 0.01M and black pigment S-428 (Trade name, Mitsui Chemical co.) of 0.001 g/ml. The polymer-gel sheet 3 and the glass substrates 10, 20 were spaced at 20 μm.

Operating Structure

By applying a positive voltage to the transparent conducting layer 11 and a negative voltage to n the transparent conducting layer 21, the polymer-gel sheet 3 was subjected to an electric field. Owing thereto, the side of the center area 3a facing the positively-charged transparent conducting layer 11 was electrically induced to be negatively charged, such that a local solvent-discharge effect resulted, and the volume of the negatively-charged side of the polymer-gel sheet 3 reduced. Additionally, the side of the center area 3a facing the negatively-charged transparent conducting layer 21 was electrically induced to be positively charged, such that a local solvent-absorption effect resulted, and the volume of the positively-charged side of the polymer-gel sheet 3 increased. The above solvent discharge and absorption effects flexed the center area of the polymer-gel sheet 3a toward the substrate 20 until contact is achieved, and the display color of the area of the substrate 20 contacting the polymer-gel sheet 3 was thereby changed to that of the platinum electrode 11.

According to the invention, the present polymer gel display, fabrication method and operating structure thereof utilize the polymer-gel sheet as a display medium. By the flexing characteristic of the polymer-gel sheet in the electrolyte, in company with added colored pigments or solutions, the colors displayed via the substrate 20 can be altered according to the on/off switch of the electric field, and a novel display device is provided. In addition to the bistability, free view-angle limitation, low driving voltage and quick response time (μs-s) of polymer gel displays, their fabrication can be easily and quickly completed by simple bonding and/or roll-to-roll processes.

The foregoing description has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

1. A polymer gel display, comprising:
a first substrate;
a polymer-gel sheet disposed on the first substrate, with two ends fixed thereto and a flexible center area;
a pair of second spacers disposed on the two ends of the polymer-gel sheet to fix the two ends to the first substrate;
a second substrate disposed on the first substrate with a preset gap therebetween, such that the polymer-gel sheet contacts the second substrate when the center area is flexed and displays via the second substrate; and
a fluid layer between the first and second substrates.

2. The polymer gel display as claimed in claim 1, further comprising a first conducting layer between the first substrate and the polymer-gel sheet, and a second conducting layer between the second substrate and the polymer-gel sheet.

3. The polymer gel display as claimed in claim 2, wherein the second conducting layer is disposed between the second substrate and the second spacers.

4. The polymer gel display as claimed in claim 2, wherein the second conducting layer is disposed between the polymer-gel sheet and the second spacers.

5. The polymer gel display as claimed in claim 4, wherein the second spacers are conducting spacers.

6. The polymer gel display as claimed in claim 1, further comprising a pair of first spacers between the polymer-gel sheet and the first substrate, wherein the first spacers are disposed corresponding to the second spacers such that the center area of the polymer-gel sheet is suspended over the first substrate.

7. The polymer gel display as claimed in claim 6, further comprising a first conducting layer between the first substrate and the polymer-gel sheet, and a second conducting layer between the second substrate and the polymer-gel sheet.

8. The polymer gel display as claimed in claim 7, wherein the second conducting layer is disposed between the second substrate and the second spacers, and the first conducting layer is disposed between the first substrate and the first spacers.

9. The polymer gel display as claimed in claim 7, wherein the second conducting layer is disposed between the polymer-gel sheet and the second spacers, and the first conducting layer is disposed between the polymer-gel sheet and the first spacers.

10. The polymer gel display as claimed in claim 7, wherein the first and second spacers are conducting spacers.

11. The polymer gel display as claimed in claim 1, wherein the first and second substrates are transparent glass substrates.

12. The polymer gel display as claimed in claim 1, wherein the polymer-gel sheet is a PMMA (polymethyl methacrylate)-gel, polyamide-gel, or polyvinyl fluoride-gel sheet.

13. The polymer gel display as claimed in claim 1, wherein the polymer-gel sheet is colored.

14. The polymer gel display as claimed in claim 1, wherein the polymer-gel sheet comprises a black pigment.

15. The polymer gel display as claimed in claim 1, wherein the polymer-gel sheet comprises a white pigment.

16. The polymer gel display as claimed in claim 1, further comprising an ion-exchange film on the polymer-gel sheet.

17. The polymer gel display as claimed in claim 1, wherein the fluid layer further comprises an electrolyte.

18. The polymer gel display as claimed in claim 1, wherein the fluid layer further comprises a pigment.

19. The polymer gel display as claimed in claim 1, wherein the fluid layer further comprises a black pigment.

20. The polymer gel display as claimed in claim 1, wherein the fluid layer further comprises a white pigment.

21. The polymer gel display as claimed in claim 1, wherein the fluid layer further comprises gas.

22. A fabrication method of a polymer-gel display, comprising:
providing a first substrate;
disposing a polymer-gel sheet on the first substrate, with two ends fixed thereon and a flexible center area;
disposing a pair of second spacers on the two ends of the polymer-gel sheet to fix the two ends to the first substrate;
disposing a second substrate on the first substrate with a preset gap therebetween, such that the polymer-gel sheet contacts the second substrate when the center area is flexed and displays via the second substrate; and
disposing a fluid layer between the first and second substrates.

23. The fabrication method as claimed in claim 22, further comprising disposing a first conducting layer between the first substrate and the polymer-gel sheet, and a second conducting layer between the second substrate and the polymer-gel sheet.

24. The fabrication method as claimed in claim 23, wherein the second conducting layer is disposed between the second substrate and the second spacers.

25. The fabrication method as claimed in claim 23, wherein the second conducting layer is disposed between the polymer-gel sheet and the second spacers.

26. The fabrication method as claimed in claim 25, wherein the second spacers are conducting spacers.

27. The fabrication method as claimed in claim 22, further comprising disposing a pair of first spacers between the polymer-gel sheet and the first substrate, whereby the first spacers are disposed corresponding to the second spacers such that the center area of the polymer-gel sheet is suspended over the first substrate.

28. The fabrication method as claimed in claim 27, further comprising disposing a first conducting layer between the first substrate and the polymer-gel sheet, and a second conducting layer between the second substrate and the polymer-gel sheet.

29. The fabrication method as claimed in claim 28, wherein the second conducting layer is disposed between the second substrate and the second spacers, and the first conducting layer is disposed between the first substrate and the first spacers.

30. The fabrication method as claimed in claim 28, wherein the second conducting layer is disposed between the polymer-gel sheet and the second spacers, and the first conducting layer is disposed between the polymer-gel sheet and the first spacers.

31. The fabrication method as claimed in claim 28, wherein the first and second spacers are conducting spacers.

32. The fabrication method as claimed in claim 22, wherein the first and second substrates are transparent glass substrates.

33. The fabrication method as claimed in claim 22, wherein the polymer-gel sheet is a PMMA (polymethyl methacrylate)-gel, polyamide-gel, or polyvinyl fluoride-gel sheet.

34. The fabrication method as claimed in claim 22, wherein the polymer-gel sheet is colored.

35. The fabrication method as claimed in claim 22, wherein the polymer-gel sheet comprises a black pigment.

36. The fabrication method as claimed in claim 22, wherein the polymer-gel sheet comprises a white pigment.

37. The fabrication method as claimed in claim 22, further comprising forming an ion-exchange film on the polymer-gel sheet.

38. The fabrication method as claimed in claim 22, wherein the fluid layer further comprises an electrolyte.

39. The fabrication method as claimed in claim 22, wherein the fluid layer further comprises a pigment.

40. The fabrication method as claimed in claim 22, wherein the fluid layer further comprises a black pigment.

41. The fabrication method as claimed in claim 22, wherein the fluid layer further comprises a white pigment.

42. The fabrication method as claimed in claim 22, wherein the fluid layer further comprises gas.

43. An operating structure of a polymer-gel display, utilizing the flexing of a polymer-gel sheet to enable the display, comprising:
a pair of substrates with a preset gap therebetween;
a polymer-gel sheet of a first color disposed between the substrates, contacting no more than one of the substrates, having two fixed ends and a flexible center area; and
a fluid layer of a second color between the substrates, displaying the second color via the substrate not contacting the polymer-gel sheet,
wherein the center area of the polymer-gel sheet flexes toward the substrate originally not contacted thereby when an external electric field is applied, such that the first color of the polymer-gel sheet is displayed via the substrate after the polymer-gel sheet and the substrate make contact.

44. The operating structure as claimed in claim 43, wherein the substrate originally not contacting the polymer-gel sheet is a transparent glass substrate.

45. The operating structure as claimed in claim 43, wherein the polymer-gel sheet is a PMMA (polymethyl methacrylate)-gel, polyamide-gel, or polyvinyl fluoride-gel sheet.

46. The operating structure as claimed in claim 43, wherein the polymer-gel sheet further comprises an ion-exchange film formed thereon.

47. The operating structure as claimed in claim 43, wherein the fluid layer further comprises an electrolyte.
